(19) United States
(12) Patent Application Publication
(10) Pub. No.: US 2017/0305108 A1
(43) Pub. Date: Oct. 26, 2017

(54) DOWN-PROOF FABRIC

(71) Applicant: Far Eastern New Century Corporation, Taipei (TW)

(72) Inventors: Yu-Chun WU, Taoyuan City (TW); Ching-Nan HUANG, Taoyuan City (TW); Kuan-Liang WEI, Taoyuan City (TW); Ya-Wen CHANG, Taoyuan City (TW)

(21) Appl. No.: 15/436,879

(22) Filed: Feb. 20, 2017

(30) Foreign Application Priority Data
Apr. 21, 2016 (TW) 105112476

(51) Int. Cl. B32B 5/24; B32B 5/18; B32B 5/02; B32B 2266/104

(52) U.S. Cl. CPC B32B 5/245; B32B 5/026; B32B 5/18; B32B 2307/724; B32B 2266/104; B32B 2307/744; B32B 2437/00; B32B 2266/0278

(57) ABSTRACT

A down-proof fabric includes a base fabric, an adhesive layer disposed on the base fabric, and at least one down-proof functional layer disposed on the adhesive layer. The down-proof functional layer includes a plurality of voids to block the penetration of the down. The present disclosure improves the drawbacks of conventional down-proof techniques and provides a light, thin, and breathable down-proof fabric with good hand feeling.

### RELATED APPLICATIONS

This application claims priority to Taiwanese Application Serial Number 105112476, filed Apr. 21, 2016, which is herein incorporated by reference.

### BACKGROUND

### Field of Disclosure

The present disclosure relates to a down-proof fabric, especially relating to a down-proof knitted fabric.

### Description of Related Art

Down jackets against cold weather are increasingly demanded these years. Since the jackets must be filled with great amounts of down, and a down layer made of the down exhibits no structural strength, each of both sides of the down layer respectively requires a fabric for coverage. Moreover, the down is so fine that it may penetrate through the fabric and thus reduce the mass of down in the down layer. The result is that the efficiency of heat preservation of the down layer is deteriorated.

To prevent the down from penetrating through the fabric, conventional down-proof techniques mainly involves the adoption of a woven fabric as a down-proof fabric, such as a high-density down-proof fabric woven by finer yarns. However, after several times of washing, the fabric structure becomes loose and reduces the down-proof efficiency. Thereafter, techniques of high-density down-proof fabrics woven by ultra-fine fibers have been developed (e.g., Taiwan Patent No. 1222473). Nonetheless, the ultra-fine fibers tend to disconnect easily during the manufacturing process due to the low Denier number, so as to lower the weaving rate with an unsatisfactory yield rate. In addition, a method of calendaring is suggested to make fabrics dense and reduce the voids between fibers (e.g., U.S. Pat. No. 8,220,499), or a method of heating is suggested to merge the surfaced fibers of fabrics to reduce the voids on the surface of the fabric to prevent the penetration of the down. Furthermore, a surface of the fabric is suggested to be coated with a down-proof film (such as a polysiloxane resin film) in order to achieve the down-proof efficiency. However, the fabric made by this method exhibits poor air permeability, hard hand feeling, and inflexibility due to the thick coating film (normally having a thickness of 30 μm). Also, the additional coating film is unsuitable for the fabrics featuring lightness and thinness.

To improve hand feeling, the low-density fabric as the outermost-layer fabric is adopted, while a layer of down-proof liner has to be added to achieve the down-proof efficiency. Nonetheless, the down-proof liner affects softness of the entire fabrics, adds extra weight, and is apt to be worn-out and pilling after washing, thus losing the down-proof efficiency.

The foregoing known down-proof methods show undesired down-proof efficiency on woven fabrics, not to mention when it is to be used on knitted fabrics. This is because the yarn density of the knitted fabrics is lower than that of the woven fabrics, so that the voids between yarns of the knitted fabrics are larger. Even if the knitted fabric is knitted as higher density, the down is still inclined to penetrate and leak out of the fabric. In the end the knitted fabric remains not well washable. In this regard, the down-proof knitted fabrics are barely seen in the market.

On the other hand, the knitted fabrics exhibit superior flexibility over woven fabrics. A person in clothes made of knitted fabrics feels more comfortable when stretching or exercising. Accordingly, if the knitted fabric is applicable to the down jackets for sports, such as for mountain climbing, the exhibited performance will be incomparable and irreplaceable by the regular woven fabrics. Given the above, it is essential to develop a down-proof technique that can be applied to knitted fabrics.

### SUMMARY

On account that the woven fabrics manufactured by foregoing down-proof techniques are limited to technical drawbacks including poor air permeability and bad hand feeling, the present disclosure aims to provide a down-proof fabric to improve the aforementioned, known disadvantages.

Hence, the present disclosure provides a down-proof fabric, which includes a base fabric, an adhesive layer disposed on the base fabric, and at least one down-proof functional layer disposed on the adhesive layer. The down-proof functional layer includes a plurality of voids, and a static friction coefficient of an exposed surface of the voids is in a range of preferably 0.39 to 1 so as to block the penetration of the down.

The present disclosure adopts an ultra-thin film as the down-proof functional layer, which can be embedded on a surface of the base fabric. The characteristic of thinness enables the base fabric to maintain fine flexibility and hand feeling, and the interior has a plurality of voids to facilitate air permeation via the voids and through the down-proof functional layer, thus improving the disadvantage of poor air permeability.

### BRIEF DESCRIPTION OF THE DRAWINGS

The present disclosure can be more fully understood by reading the following detailed description of the embodiment, with reference made to the accompanying drawings as follows:

FIG. 1 illustrates a lateral view of a three-dimensional profile of a down-proof fabric in accordance with the present disclosure.

FIG. 2A to 2D illustrate cross sectional views of manufacturing a down-proof fabric in respective stages in accordance with the present disclosure.

FIG. 3 illustrates a cross sectional view of forming a down-proof fabric in accordance with some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The singular forms “a,” “an” and “the” used herein include plural referents unless the context clearly dictates otherwise. Therefore, reference to, for example, a gate stack includes embodiments having two or more such gate stacks, unless the context clearly indicates otherwise. Reference throughout this specification to “one embodiment” or “an embodiment” means that a particular feature, structure, or characteristic described in connection with the embodiment is included in at least one embodiment of the present disclosure. Therefore, the appearances of the phrases “in one embodiment” or “in an embodiment” in various places throughout this specification are not necessarily all referring to the same embodiment. Further, the particular features, structures, or characteristics may be combined in any suitable manner in one or more embodiments. It should be appreciated that the following figures are not drawn to scale; rather, these figures are intended for illustration.

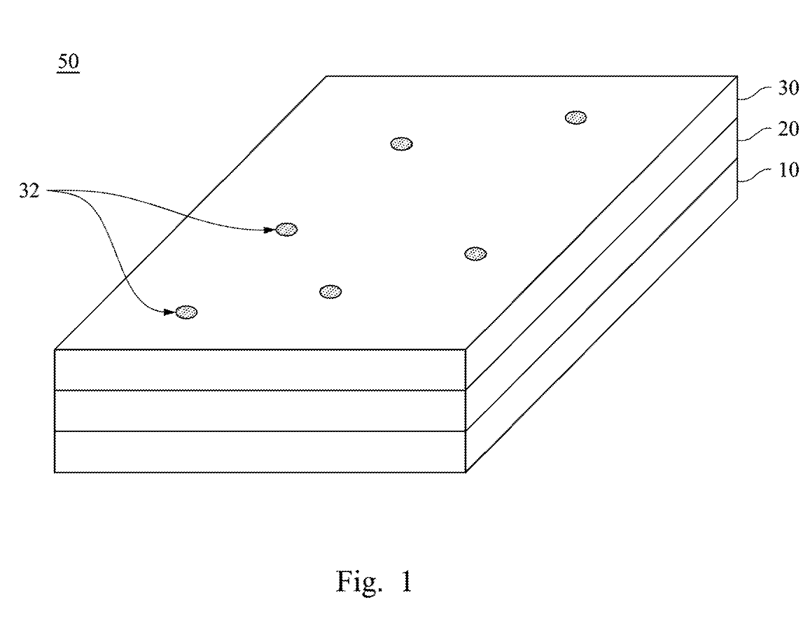

Referring to FIG. 1, which illustrates a down-proof fabric 50 in accordance with the present disclosure, which includes a base fabric 10, an adhesive layer 20 disposed on the base fabric 10, and at least one down-proof functional layer 30 disposed on the adhesive layer 20. The down-proof functional layer 30 includes a plurality of voids 32.

The base fabric 10 applied in the present disclosure may be a knitted fabric or a woven fabric, and is not particularly limited. Preferably, the base fabric 10 is a knitted fabric.

The adhesive layer 20 applied in the present disclosure may include an adhesive.

The category of the aforementioned adhesive includes but is not limited to polyurethane resin.

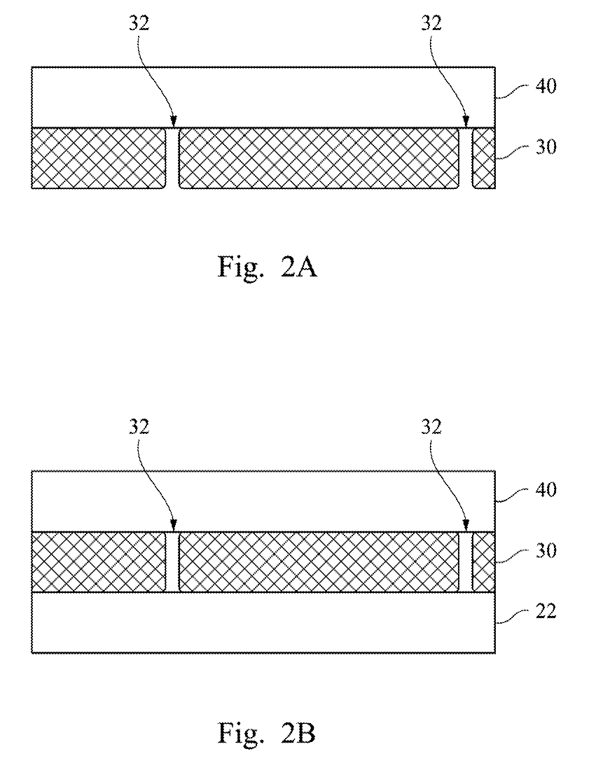

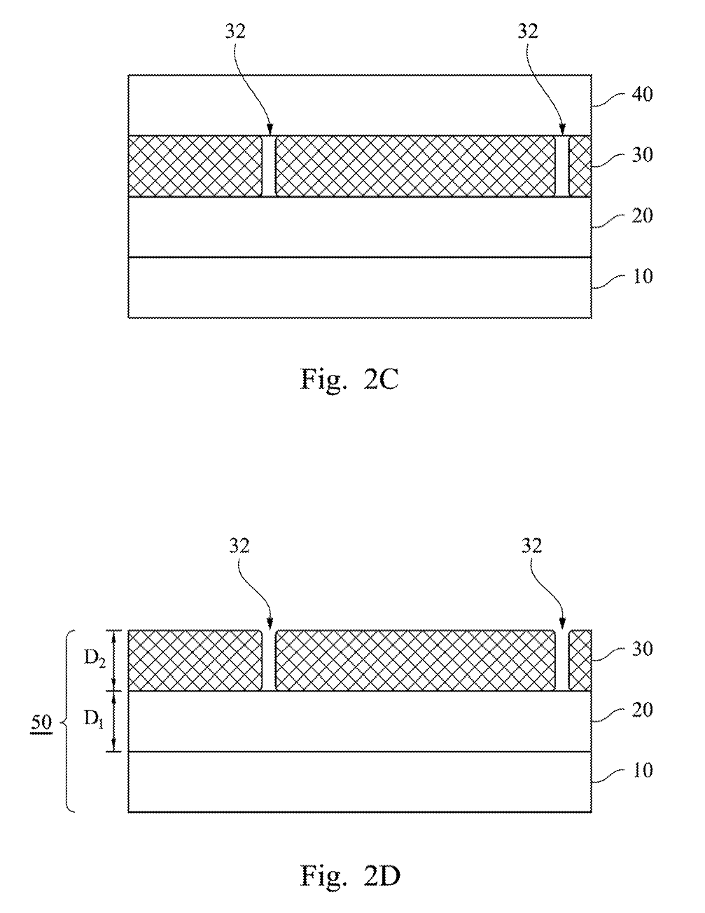

Referring to FIGS. 2A to 2D, which illustrate cross sectional views of manufacturing a down-proof fabric 50 in respective stages in accordance with the present disclosure. FIGS. 2A to 2D refer to some embodiments, but are not limited thereto. Referring to FIG. 2A, an embodiment includes coating a down-proof functional layer 30 onto a release paper 40. The down-proof functional layer 30 includes a plurality of voids 32. Referring to FIG. 2B, in order to dispose an adhesive to form an adhesive layer 20, the adhesive is preferably mixed with a solvent to form a mixed reagent (unillustrated), and then the mixed reagent is coated onto the down-proof functional layer 30 and partially dried to form a pre-adhesive layer 22. Subsequently, referring to FIG. 2C, the exposed side (i.e. the side not in contact with the down-proof functional layer 30) of the pre-adhesive layer 22 is adhered to the base fabric 10 and then completely solidifies to form an adhesive layer 20. Lastly, referring to FIG. 2D, the release paper 40 is removed, and a down-proof fabric 50 is formed.

To evenly adhere the adhesive layer 20 of the instant application to the base fabric 10, preferably at the stage of partial drying of the mixed reagent, the mixed reagent is not completely dried and solidified to retain some solvent therein. When the pre-adhesive layer 22 adheres to the base fabric 10, the pre-adhesive layer 22 still retains some softness and fluidity due to incomplete solidification. Thus some of the mixed reagent will flow into the voids of the base fabric 10, facilitating even adhesion to the base fabric 10 and also strengthening fixation. After a while of standing for the complete drying and curing (with complete removal of the solvent), an adhesive layer 20 evenly adhered to the base fabric 10 is obtained.

For instance, a solid content of the mixed reagent before coating is deployed to be 30 wt % (with the content of the solvent at 70 wt %). After the procedure of partial drying, the solid content of the mixed reagent would rise to 70 wt % (with the content of the solvent at 30 wt %). After further standing and curing, the mixed reagent would be completely dried to form an adhesive layer 20.

The range of the solid content in the mixed reagent is not particularly limited, and can be modified to facilitate coating depending on the categories of the adhesive and the solvent.

The category of the aforementioned solvent includes but is not limited to methyl ethyl ketone, ethyl acetate, or dimethylformamide.

Methods for coating the mixed reagent applied in the present disclosure are not particularly limited, and may be selectively chosen in account of the convenience of implementation. The coating method includes but is not limited to spin coating, wire bar coating, dip coating, slit coating, dot coating, or roll-to-roll coating.

During the process of the flowing of the mixed reagent of the pre-adhesive layer 22 into the voids of the base fabric 10, the yarn structure of the base fabric 10 would destruct the continuity of the pre-adhesive layer 22, which enables air to permeate through the voids and give rise to the effect of air permeability.

For further improve the overall efficiency of air permeability, dot coating is preferably adopted to dispose the mixed reagent.

Hence, the adhesive layer 20 of the present disclosure is substantively continuous or discontinuous.

A thickness D₁ of the adhesive layer 20 (excluding the portion flowing into the base fabric 10) is preferably in a range of 1 μm to 10 μm, more preferably 1 μm to 8 μm, and the most preferably 1 μm to 5 μm.

Methods for coating the down-proof functional layer 30 applied in the present disclosure are not particularly limited, and may be selectively chosen in account of the convenience of implementation. The coating method includes but is not limited to spin coating, wire bar coating, dip coating, slit coating, blade coating, or roll-to-roll coating.

In order to maintain fine flexibility of the down-proof fabric 50 and sustain the wearing comfort as well as good hand feeling with sufficient down-proof effect, a thickness D₂ of the down-proof functional layer 30 is preferably in a range of 1 μm to 10 μm, more preferably 1 μm to 8 μm, and the most preferably 1 μm to 5 μm.

The material adopted in the down-proof layer 30 is made of a down-proof composition. The down-proof composition includes a polyurethane resin and an anti-slip agent.

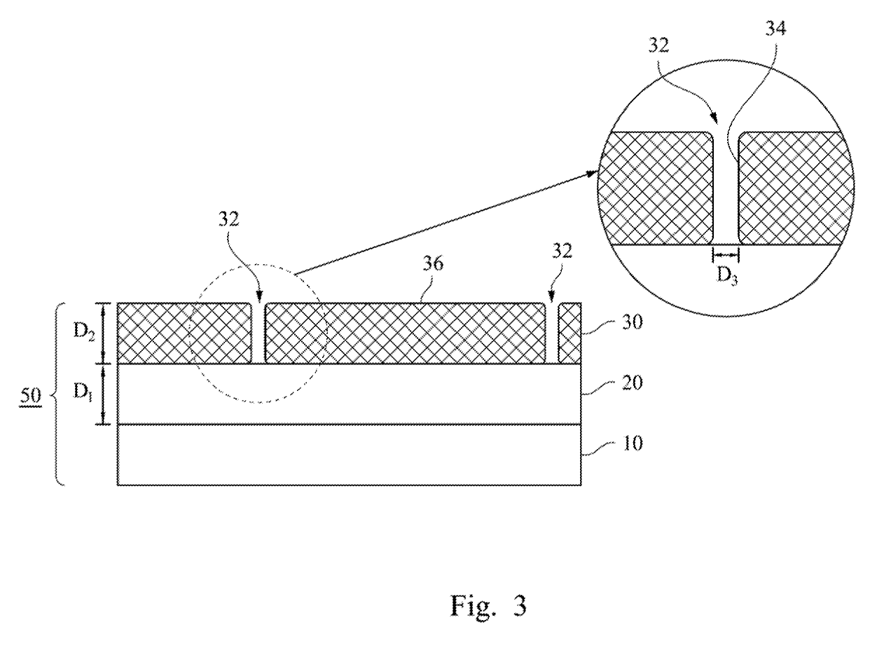

Referring to FIG. 3, the down-proof functional layer 30 has a plurality of voids 32, and a size D₃ of the void 32 is in a range of 0.2 μm to 10 μm.

In one embodiment, the formation of voids 32 is due to the incomplete miscibility between the polyurethane resin and the anti-slip agent, along with the exertion of a shear force by a blade or a wire bar when the down-proof functional layer 30 is coated. As a result, voids 32 are formed in the coating film. However, formation of voids 32 is not limited to the foregoing mechanism only.

Since the thickness D₂ of the down-proof functional layer 30 is thinner than the conventional coating films with down-proof functions (with a thickness of about 30 μm). Also, the plurality of voids 32 of the down-proof functional layer 30 facilitates air permeability, which makes the down-proof fabric 50 more breathable than conventional down-proof coating films without voids or down-proof fabrics with lined down-proof cloth.

In the embodiments of the present disclosure, the range of the static friction coefficient of the surface 34 of the void 32 is between 0.39 and 1. When the down is going to penetrate through the void 32, the down contacts the surface 34 of the void 32. Since the effect of the static friction, the down is inhibited to move outward any further. Penetration of the down is prevented thereby.

Due to the uniform composition of the down-proof functional layer 30, the static friction coefficient of the surface 34 of the void 32 inside the down-proof functional layer 30 and the static friction coefficient of the surface 36 of the down-proof functional layer 30 are the same.

In the embodiments of the present disclosure, a proper range of a solubility parameter of the anti-slip agent is chosen to manipulate the size D₃ of the void 32. The down do not penetrate through owing to the overly large size D₃ even when the void 32 is formed. More preferably, a solubility parameter of the anti-slip agent is in a range of 9 to 10 (cal/cm³)^{1/2} to effectively manipulate the range of the size D₃.

If the weight percent of the anti-slip agent in the down-proof functional layer 30 is too low, the static friction coefficient on the surface 34 of the void 32 will be too low. The down-proof functional layer 30 would fail to prevent the penetration of the down. On the other hand, if the weight percent of the anti-slip agent is too high, it forms too many voids 32 and thus the structural strength of the down-proof functional layer 30 will be influenced. Thus, the anti-slip agent has a preferred concentration of 2 wt % to 10 wt % in the down-proof functional layer 30.

In one embodiment of the present disclosure, the anti-slip agent is polysiloxane resin.

In one embodiment of the present disclosure, the anti-slip agent is a comb-like acrylic polymer.

The aforementioned comb-like acrylic polymer comprises a chain X

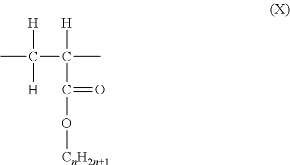

and a chain Y

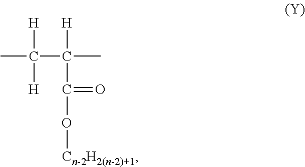

and when the chain X is 100 parts by weight, the chain Y is in a range of 40 to 60 parts by weight, wherein n is 14 to 18.

For example, in one embodiment of the present disclosure, the anti-slip agent can be a polymer I, having a chain combination:

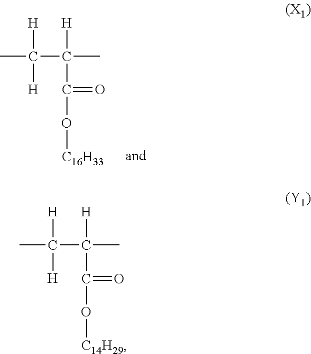

and when the chain X₁ is 100 parts by weight, the chain Y₁ is 55.56 parts by weight.

In another embodiment of the present disclosure, the anti-slip agent can be a polymer II, having a chain combination:

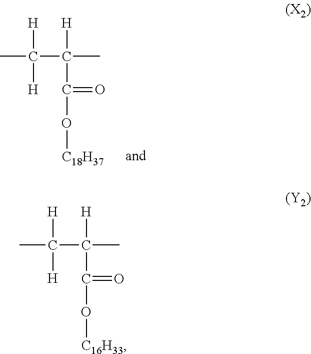

and the chain X₂ is 100 parts by weight, and the chain Y₂ is 50 parts by weight.

In another embodiment of the present disclosure, the anti-slip agent can be a polymer II, comprising a chain:

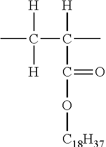

The following polymer IV, V and VI is not suitable for the present disclosure, due to the undesired range of the solubility parameter of the anti-slip agent. Polymer IV has a chain combination as follows:

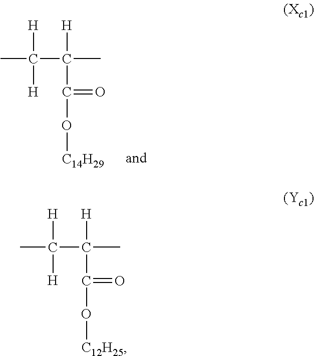

and when the chain Xₑ is 100 parts by weight, the chain Y₁ is 66.67 parts by weight.

Polymer V has a chain combination:

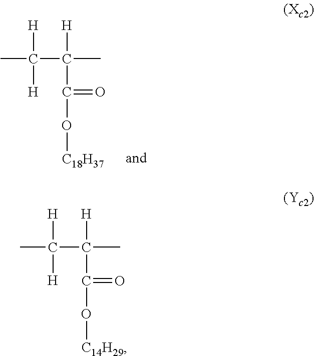

and when the chain X_{c2} is 100 parts by weight, the chain Y_{c2} is 56.82 parts by weight.

Polymer VI has a chain combination:

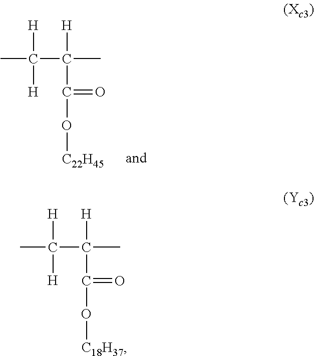

and when the chain Xₑ₃ is 100 parts by weight, the chain Y_{c3} is 133.33 parts by weight.

The polyurethane resin in the present disclosure is not particularly limited and can be hydrophilic polyurethane resin or hydrophobic polyurethane resin.

The polyurethane resin in the present disclosure is not particularly limited and can be solvent type polyurethane resin or non-solvent type polyurethane resin (also called reactive type polyurethane resin). In an embodiment of the present disclosure, for the convenience in the process and the handy operation of the equipment, the solvent type polyurethane resin is preferred.

The following are some embodiments which illustrate more details of the present disclosure. The embodiments are herein presented for explaining rather than limiting the present disclosure. The scope of the present disclosure should be defined in the claims that follow.

Chemicals and Equipment

The chemicals and equipment need to be used in the present disclosure are listed as follows:
1. Polyurethane: Gicap Development Co., product model ADB585; solid content is 30 wt %, and the solvent is Dimethylformamide.
2. Anti-slip agent A: Far Eastern New Century Company, product model NF14, or polymer I as aforementioned; solid content is 10 wt %, and the solvent is Butanone.
3. Anti-slip agent B: Far Eastern New Century Company, product model NF16, or polymer II as aforementioned; solid content is 10 wt %, and the solvent is Butanone.
4. Anti-slip agent C: Far Eastern New Century Company, product model NF18, or polymer III as aforementioned; solid content is 10 wt %, and the solvent is Butanone.
5. Anti-slip agent D: Cherng Long Company, product model CL-209; polysiloxane resin; solid content is 10 wt/o, and the solvent is Ethyl acetate.
6. Anti-slip agent E: Far Eastern New Century Company, product model NF12, or polymer IV as aforementioned; solid content is 10 wt %, and the solvent is Butanone.
7. Anti-slip agent F: Far Eastern New Century Company, product model NF19, or polymer V as aforementioned; solid content is 10 wt %, and the solvent is Butanone.
8. Anti-slip agent G: Far Eastern New Century Company, product model NF22, or polymer VI as aforementioned; solid content is 10 wt %, and the solvent is Butanone.
9. Anti-slip agent H: Taiwan Wax Company, product model WAX-156.
10. Anti-slip agent I: Taiwan Wax Company, product model WAX-180.
11. Adhesive: Gicap Development Co., product model ADM411; solid content is 30 wt/o, and the solvent is Toluene.
12. Contactless injection type dot coating machine: Ming Hao Company, product model MJET-C-2.
13. Static friction coefficient tester: Testing Machines Inc., product model 32-07 monitor/slip and friction.
14. Air permeability tester: Go-in International Co., product model FX3300 IV.

### Embodiment 1

The method for preparing the fabric having down-proof function, including the following steps:
1. 9 kg Polyurethane resin and 1 kg anti-slip agent A were mixed to form a mixed solution.
2. Blade was used to dispose the mixed solution on the release paper (Hui Jen Shih Yeh company, the product number is Black silk) to form a wet film with a thickness of 20 μm. Then a down-proof functional layer with a thickness of 5 μm was obtained by heating in an oven at 130° C. for 3 minutes.
3. 5 ml adhesive was provided in a contactless injection type dot coating machine to dispose on the down-proof functional layer by a thickness of 80 μm, and then heated in an oven at 130′C for 6 minutes. The resulting incompletely solidified pre-adhesive layer with a thickness of 30 μm was yielded.
4. A knitted fabrics with 30d/36f was used as the base fabric and a roller was used to apply a 2.5 kg pressure onto the knitted fabrics to have evenly adhered to the pre-adhesive layer. After 24 hours a completely solidified adhesive layer was obtained. Finally, the release paper was removed to have a down-proof fabric.

Air Permeability Test

A down-proof fabric which was made by the above method was cut into the size of 7 cm×7 cm and then be placed on a air permeability tester. Standardized testing method ASTMD 737 was employed. The test area was 38 cm², and the test pressure was 125 Pa. The test result was listed as Table 1.

The maximum static friction coefficient test

Two down-proof fabrics which were made by the above method were stacked where the faces having the down-proof functional layer of respective fabrics were opposing to each other. Static friction coefficient tester was used to investigate the maximum static friction coefficient of the surface of the down-proof functional layer.

The test result was listed as Table 2.

Down-Proof Effect Test

This embodiment was performed under the Nike standard test NAL™ 9100 VI. Intertek Company was commissioned to conduct the test.

Test Steps were as Follows:

1. Manufacturing knitted fabrics pillow stuffed with down: Two down-proof fabrics which were made by the above method were cut into the size of 17 cm×17 cm and stacked up. After stitched three sides at 1 cm inwardly away from each edge, 12 g of down was stuffed into (75% feather/25% down). Sewed up the last one edge to make a small pillow.
2. Washed the small pillow in a washing machine at 40° C. (water 2 kg with detergent 1 wt %) for 10 minutes each time, and washed three times continuously.
3. Used tumble dry low at about 50° C. Observed the exterior of the pillow and then counted the penetration number of the down. Used the method of NAL™ 9100 VI as the standard. It was qualified when the number of the down penetration count was less than 60. Test result was listed as Table 2.

### Embodiments 2 to 4

The method in the embodiment 2 to 4 are the same as that in embodiment 1, except that the anti-slip agent was B, C and D, respectively.

### Comparison Embodiments 1 to 5

The method in the comparison embodiments 1 to 5 are the same as that in the embodiment 1, except that the anti-slip agent was E, F, G, H and I, respectively.

TABLE 1

| | Air permeability |
|---|---|
| | (cm³/cm²/s) |
| Embodiment 1 | 0.56 |
| Embodiment 2 | 0.13 |
| Embodiment 3 | 0.12 |
| Embodiment 4 | 0.46 |
| Comparison embodiment 1 | 1.32 |
| Comparison embodiment 2 | 0.23 |
| Comparison embodiment 3 | 0.66 |
| Comparison embodiment 4 | 0.34 |
| Comparison embodiment 5 | 0.51 |

TABLE 2

| | The | solubility | | |
|---|---|---|---|---|
| | maximum | parameter of | | Down- |
| | static friction | anti-slip agent | Void size | proof |
| | coefficient | (cal/cm³)^{1/2} | (μm) | test |
| Embodiment 1 | 0.545 | 10 | 10 | Qualified |
| Embodiment 2 | 0.471 | 9.6 | 2 | Qualified |
| Embodiment 3 | 0.416 | 9.4 | 2 | Qualified |
| Embodiment 4 | 0.392 | 9.1 | 8 | Qualified |
| Comparison | 0.602 | 10.5 | 20 | Unqualified |
| embodiment 1 | | | | |
| Comparison | 0.383 | 9.3 | 4 | Unqualified |
| embodiment 2 | | | | |
| Comparison | 0.346 | 8.9 | 12 | Unqualified |
| embodiment 3 | | | | |
| Comparison | 0.312 | 9.2 | 6 | Unqualified |
| embodiment 4 | | | | |
| Comparison | 0.289 | 9.0 | 10 | Unqualified |
| embodiment 5 | | | | |

From the air permeability test according to Table 1, it can be found that the void resulted from adding proper anti-slip agent can improve air permeability. Generally, the air permeability of breathable windproof fabric is between 0.1 and 1 (cm³/cm²/s). In the embodiments 1 to 4, the air permeability of each was improved significantly in comparison with the conventional down-proof fabric, with positive feedbacks from the wearers. In comparison embodiment 1, the void is so large that the air permeability is as high as 1.32 (cm³/cm²/s). When being put on, the person who wears it can feel the wind so that no sufficient windproof effect was achieved. It is not a good option for a down-proof fabric.

From the embodiments 1 to 4 according to Table 2, when the maximum static friction coefficient of the surface of the down-proof functional layer is larger than 0.39, there is enough static friction that can prevent the penetration of the down and thus achieve good down-proof efficiency.

From the comparison embodiments 2 to 5 according to Table 2, when the maximum static friction coefficient of the surface of the down-proof functional layer is less than 0.39, there is not enough static friction that can prevent the penetration of the down. After washing for three times in washing machine, the down penetration count was more than 60. No down-proof effect is achieved.

In addition, from the comparison embodiment 1 according to Table 2, one can realize that if the solubility parameter of the chosen anti-slip agent is larger than 10 (cal/cm³)^{1/2}, the resulting void will be too large (void size is 20 μm) owing to the poor miscibility of the anti-slip agent and the polyurethane resin. Even though the maximum static friction coefficient of the surface of the down-proof functional layer is larger than 0.39, it still fails to effectively prevent the penetration of the down.

While the foregoing is directed to particular embodiments of the present disclosure, the embodiments are not limiting the invention and, by any person skilled in the art, other and further embodiments of the disclosure may be devised without departing from the basic scope of the disclosure. The scope of protection of the present invention shall thus be dictated by the claims follow.

What is claimed is:

1. A down-proof fabric, comprising:
a base fabric;
an adhesive layer disposed on the base fabric; and
at least a down-proof functional layer disposed on the adhesive layer,
wherein the down-proof functional layer comprises a plurality of voids, wherein a static friction coefficient of a surface of the voids is in a range of 0.39 to 1.

2. The down-proof fabric of claim 1, wherein a thickness of the down-proof functional layer is in a range of 1 μm to 10 μm.

3. The down-proof fabric of claim 1, wherein a thickness of the down-proof functional layer is in a range of 1 μm to 8 μm.

4. The down-proof fabric of claim 1, wherein a thickness of the down-proof functional layer is in a range of 1 μm to 5 μm.

5. The down-proof fabric of claim 1, wherein the down-proof functional layer is made of a down-proof composition, wherein the down-proof composition comprises a polyurethane resin and an anti-slip agent.

6. The down-proof fabric of claim 5, wherein the anti-slip agent has a concentration of 2 to 10 wt % in the down-proof functional layer.

7. The down-proof fabric of claim 5, wherein the anti-slip agent is a comb-like acrylic polymer.

8. The down-proof fabric of claim 7, wherein the comb-like acrylic polymer comprises a chain X: 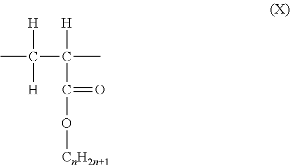
and a chain Y: 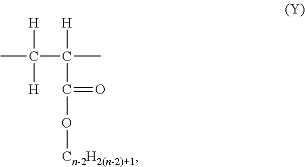
and, when the chain X is 100 parts by weight, the chain Y is in a range of 40 to 60 parts by weight, wherein n is 14 to 18.

9. The down-proof fabric of claim 7, wherein the comb-like acrylic polymer comprises a chain as follows:

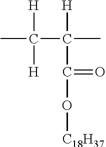

10. The down-proof fabric of claim 5, wherein the polyurethane resin is a hydrophobic polyurethane resin.

11. The down-proof fabric of claim 5, wherein the polyurethane resin is a solvent-type polyurethane resin.

12. The down-proof fabric of claim 5, wherein a solubility parameter of the anti-slip agent is in a range of 9 to 10 (cal/cm³)^{1/2}.
